(19) United States
(12) Patent Application Publication
(10) Pub. No.: US 2017/0192494 A1
(43) Pub. Date: Jul. 6, 2017

(54) WEARABLE INTERACTIVE GAMING DEVICE

(71) Applicants: Shobhit NIRANJAN, Bangalore (IN); Rajat DHARIWAL, Bangalore (IN)

(72) Inventors: Shobhit NIRANJAN, Bangalore (IN); Rajat DHARIWAL, Bangalore (IN)

(21) Appl. No.: 14/988,650

(22) Filed: Jan. 5, 2016

(51) Int. Cl. G06F 3/01; G06F 3/16; A63F 13/54; A63F 13/212; A63F 13/35

(52) U.S. Cl. CPC G06F 3/011; A63F 13/212; A63F 13/35; A63F 13/54; G06F 3/16

(57) ABSTRACT

The present invention relates to wearable interactive gaming device and a method for enabling interactive gaming. The wearable interactive gaming device includes at least one wearable unit wearable on a player. The at least one wearable unit includes a display unit, a motion sensor unit, a communication unit, and a receiver unit. The display unit enables setting up of a game and indicates parameters in the game. The motion sensor unit senses gestures performed by the player. The communication unit communicates interactions with one of at least one robot device and at least one wearable interactive gaming device using mesh network. The communication unit includes a hardware interface unit that allows attachment of controller units in accordance with the game. The receiver unit receives the interactions from at least one competing player. The wearable interactive gaming device operates on a gaming platform that is used by developers for publishing games.

### FIELD OF THE INVENTION

The present invention generally relates to gaming devices and more particularly to a wearable interactive gaming device.

### BACKGROUND TO THE INVENTION

Conventionally, various types of games have been played both indoors and outdoors by people to increase social interaction and encourage physical activity. With advent of technology, however, the games today are mostly technology based and are being played within confines of a room using electronic devices, for example a television, a mobile device, and the like. The games are played either between a single player and a virtual interface or between multiple players connected through the virtual interface. Such games increase screen time, decrease the social interaction, and cause various health issues. Few gaming devices have been developed as standalone distributed systems capable of communicating to other gaming devices. Such gaming devices can operate without need of the electronic devices or Internet, and without the virtual interface. However, such gaming devices are only configured for a single game, for example a shooting game, a laser tag game, and the like. Moreover, most of the gaming devices are either non-intelligent, non-programmable, non-networked, or do not allow two-way communications.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

An example of a wearable interactive gaming device includes at least one wearable unit wearable on a player. The at least one wearable unit includes a display unit, a motion sensor unit, a communication unit, and a receiver unit. The display unit is configured to enable setting up of a game by the player. The display unit is further configured to indicate, to the player, a plurality of parameters in the game. The motion sensor unit is configured to sense a plurality of gestures performed by the player during the game. The communication unit is configured to communicate one or more interactions with one of at least one robot device and at least one wearable interactive gaming device. The communication unit is further configured to communicate data within the wearable interactive gaming device. The communication unit uses a mesh network to communicate with one of the at least one robot device and the at least one wearable interactive gaming device. The receiver unit is configured to receive the one or more interactions from at least one competing player. The one or more interactions include one or more digital codes and is based on a set of rules associated with the game.

An example of a method of enabling interactive gaming includes obtaining, by a wearable interactive gaming device, a game to be played by a player of the wearable interactive gaming device. The method also includes communicating, by the wearable interactive gaming device, one or more interactions with one of at least one robot device and at least one wearable interactive gaming device. A mesh network is used for communication with one of the at least one robot device and the at least one wearable interactive gaming device. Further, the method includes receiving, by the wearable interactive gaming device, the one or more interactions from at least one competing player. The one or more interactions include one or more digital codes and is based on a set of rules associated with the game.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which:

FIG. 1 is a block diagram of an environment, in accordance with an embodiment;

FIG. 2 is a block diagram representation of a wearable interactive gaming device, in accordance with an embodiment;

FIG. 3 is an example representation of a wearable interactive gaming device, in accordance with an embodiment;

FIG. 4 illustrates an example flow diagram of a method of enabling interactive gaming, in accordance with an embodiment;

FIG. 5 is an example representation of a body unit of a wearable interactive gaming device, in accordance with an embodiment;

FIG. 6 is an example representation of an arm unit of a wearable interactive gaming device, in accordance with an embodiment; and

FIG. 7 is an example representation of a wearable interactive gaming device on a player, in accordance with an embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

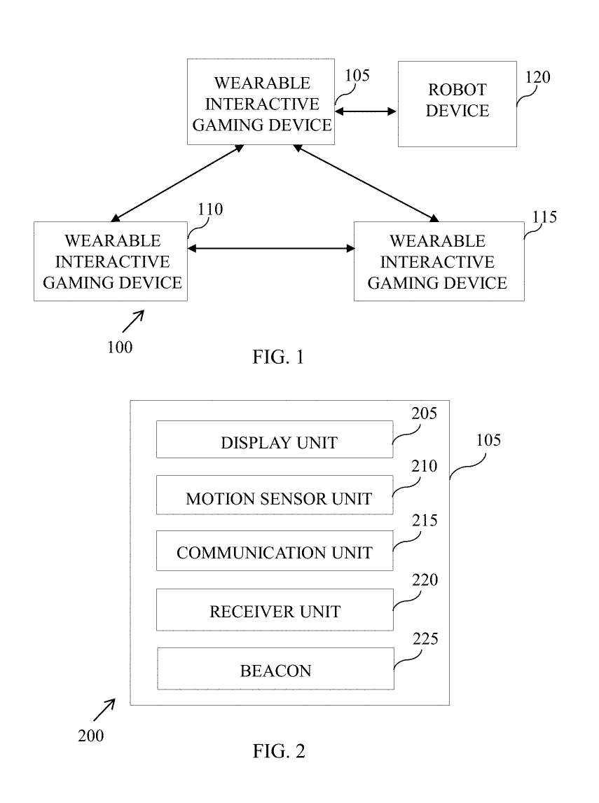

FIG. 1 is an example representation of an environment 100, in accordance with an embodiment. The environment 100 is used for interactive gaming and includes a wearable interactive gaming device 105, a wearable interactive gaming device 110, and a wearable interactive gaming device 115. FIG. 1 is explained with respect to three wearable interactive gaming devices, for example the wearable interactive gaming device 105, the wearable interactive gaming device 110, and the wearable interactive gaming device 115. However, it should be noted that a plurality of wearable interactive gaming devices other than the wearable interactive gaming devices in the environment 100 can also be similarly included in the environment 100.

Each wearable interactive gaming device is a mesh network device. The wearable interactive gaming device 105, the wearable interactive gaming device 110, and the wearable interactive gaming device 115 together form a mesh network and are also referred to as mesh nodes in the mesh network that are able to directly communicate with each other. Examples of the mesh network includes, but are not limited to, a Local Area Network (LAN), a Wireless Local Area Network (WLAN), a Virtual Local Area Network (VLAN), and the like. Herein, the ‘mesh network’ refers to a self-organizing network, direct as well as multi-hop transmission enabled, and secure. The mesh network is built from a plurality of mesh nodes that can assemble the mesh network, dynamically adapt to device failure and degradation (also referred to as self-healing), manage movement of the mesh nodes, and react to changes in task and network requirements. In an example, the mesh network can be arranged as a full mesh topology or a partial mesh topology. In the full mesh topology the mesh nodes are connected directly to each other mesh node. In the partial mesh topology, the mesh nodes are connected to only some, not all, of other mesh nodes.

The wearable interactive gaming device 105 can obtain a game, for example from a cloud network. The wearable interactive gaming device 105 can further set up the game and include the wearable interactive gaming device 110 and the wearable interactive gaming device 115 as competing players. The player and the competing players can further view a plurality of parameters in the game. A plurality of gestures performed by the player of the wearable interactive gaming device 105 during the game can be sensed by the wearable interactive gaming device. The wearable interactive gaming device 105 can communicate one or more interactions with one of at least one robot device, for example the robot device 120, the wearable interactive gaming device 110 and the wearable interactive gaming device 115. The wearable interactive gaming device 105 can further receive, during course of the game, the one or more interactions from at least one competing player. An example embodiment of the wearable interactive gaming device 105 is explained with reference to FIG. 2.

FIG. 2 is a block diagram representation 200 of the wearable interactive gaming device 105, in accordance with an embodiment. The wearable interactive gaming device 105 can include one or more wearable units that are wearable on a player. Each wearable unit of the wearable interactive gaming device 105 includes a display unit 205, a motion sensor unit 210, a communication unit 215, and a receiver unit 220. The wearable interactive gaming device 105 can also include a beacon 225 fitted on the wearable unit.

The display unit 205 is configured to enable setting up of a game by the player. In an example, the display unit 205 can include a light emitting diode display unit and a liquid crystal display unit. In some embodiments, the game can be selected by the player from one of a plurality of games of a publisher that are stored on a cloud network. The player can also personalize game setup options for each game. The display unit 205 is further configured to indicate, to the player, a plurality of parameters in the game. The player can further personalize the wearable interactive gaming device 105 by setting up personal details, preferences, colour schemes, and the like.

The motion sensor unit 210 is configured to sense a plurality of gestures performed by the player during the game. For example, the player can perform an infinity symbol gesture to represent a super shield option in the game. In another example, the player can perform a cross symbol gesture to represent a super sweep option in the game. The motion sensor unit 210 is further configured to track one or more fitness parameters of the player. Examples of the one or more fitness parameters include, but are not limited to, heart rate, step count, calories burnt, and the like.

The communication unit 215 is configured to communicate one or more interactions with one of at least one robot device and at least one wearable interactive gaming device. Herein, the ‘one or more interactions’ include data that is exchanged between the wearable interactive gaming device 105 and other wearable interactive gaming devices and robot devices in vicinity of the wearable interactive gaming device 105. The communication unit 215 is further configured to communicate data within the wearable interactive gaming device 105. In an example, the data is exchanged internally within the at least one wearable unit (for example, the body unit 302 and the arm unit 304). The communication unit 215 uses a mesh network to communicate with the at least one wearable interactive gaming device. Herein, the ‘at least one wearable interactive gaming device’ refers to a wearable interactive gaming device other than the wearable interactive gaming device 105 that is present in the mesh network. The communication unit 215 further includes a hardware interface unit configured to allow attachment of one or more controller units in accordance with the game. Examples of the controller units include, but are not limited to, buttons, joysticks, and the like. The communication unit 215 includes a speaker configured to provide one or more audio outputs associated with the game.

The receiver unit 220 is configured to receive the one or more interactions from at least one competing player. The one or more interactions include one or more digital codes and is based on a set of rules associated with the game.

The beacon 225 is configured to emulate one or more functionalities of the at least one competing player on detachment from the wearable interactive gaming device 105. The beacon 225 is attached to the wearable interactive gaming device 105 and can be detached easily. The player can detach the beacon 225 from the wearable interactive gaming device 105 and play the game against the beacon 225.

The wearable interactive gaming device 105 is further configured to connect to a cloud network for retrieving one or more updates associated with the game.

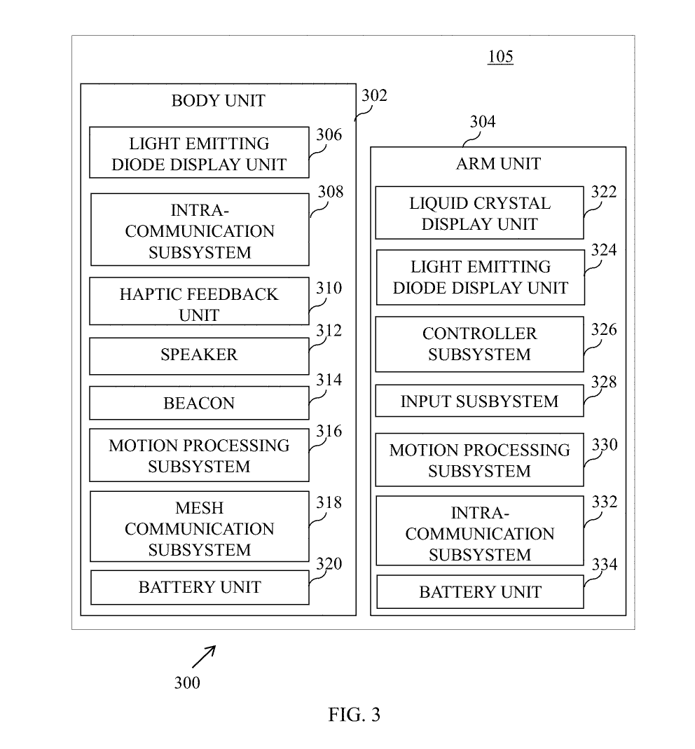

The wearable interactive gaming device 105 operates on a gaming platform, the gaming platform being used by one or more developers for publishing one or more games. An example representation of the wearable interactive gaming device 105 including two wearable units is explained with reference to FIG. 3.

FIG. 3 is an example representation 300 of the wearable interactive gaming device 105, in accordance with one embodiment. The wearable interactive gaming device 105 worn by a player includes one or more wearable units that enable interaction with other players through physical line-of-sight interactions. In the example representation 300, the wearable interactive gaming device 105 includes two wearable units, for example a body unit 302 and an arm unit 304. The wearable units can communicate wirelessly to maintain operating parameters of the wearable interactive gaming device 105 and share information on need basis. The body unit 302 is worn across chest of the player, and the arm unit 304 is worn over wrist of one arm and can extend to top palm of the arm. Other examples of the wearable units include, but are not limited to, a head mounted unit, and the like. The wearable interactive gaming device 105 can also be integrated with virtual reality enabled head mounted display units, for example Google Glass, Occulus VR type units, and the like.

The player wears the one or more wearable units, for example the body unit 302 and the arm unit 304, of the wearable interactive gaming device 105 to play various games either as a single player or with multiple players.

The body unit 302 includes a light emitting diode (LED) display unit 306, an intra-communication subsystem 308, a haptic feedback unit 310, a speaker 312, a beacon 314, a motion processing subsystem 316, a mesh communication subsystem 318, and a battery unit 320. The LED display unit 306 is representative of the display unit 205 of FIG. 2. The intra-communication subsystem 308, the haptic feedback unit 310, the speaker 312, the mesh communication subsystem 3218 and the battery unit 320 is representative of the communication unit 215 of FIG. 2. The motion processing subsystem 316 is representative of the motion sensor unit 210 of FIG. 2. The beacon 314 is representative of the beacon 225 of FIG. 2.

The body unit 302 can include one or more portions, for example a chest portion, a left shoulder portion, a right shoulder portion, and a back portion. Each of the one or more portions include multiple multi-colour LED display units, for example the LED display unit 306, in a specific pattern, which indicate different parameters in a particular game. The chest portion and the back portion includes receiver units which receive one or more interactions from other competing players. The chest unit includes the battery unit 320 for the body unit 302, the intra-communication subsystem 308 to communicate with the arm unit 304, and the haptic feedback unit 310 at multiple locations. The chest unit can further include the speaker 312, the motion processing subsystem 316, and the mesh communication subsystem 318 that establishes a network in background with all other wearable interactive gaming devices within a vicinity, for example in a peer-to-peer configuration. The speaker 312 in the wearable interactive gaming device 105 provides background music or game sounds, audible feedback, voice based instructions and the like.

The body unit 302 registers the one or more interactions by other competing players in the game and reacts or informs the player by using the LED display units, while simultaneously passing information to the arm unit 304.

In an example, the beacon 314 is a passive system for as long it is attached to the wearable interactive gaming device 105. The beacon 314 is provided for single player games, and can be detached from the wearable interactive gaming device 105 to emulate basic functionality of receiving codes, interpreting the codes, effecting sounds and the LED displays based on the same. A player with the wearable interactive gaming device can take the beacon out and play with the beacon as a competing player or device.

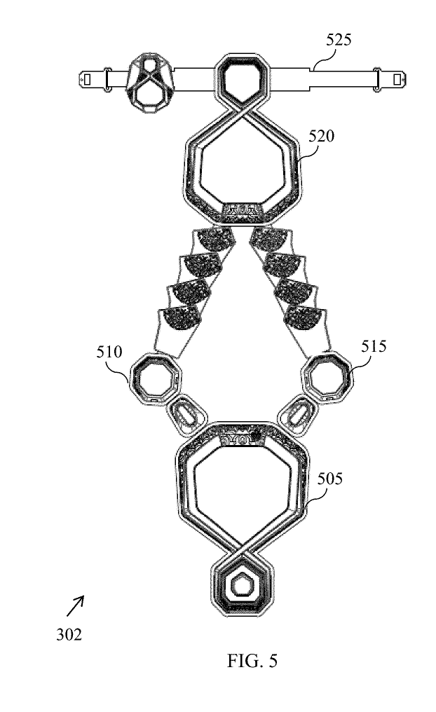

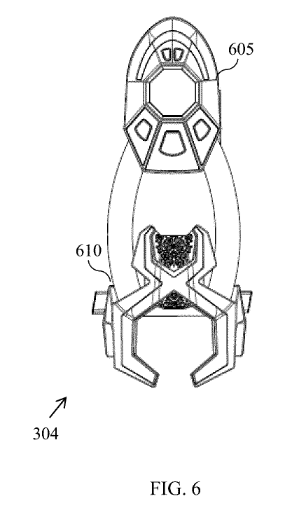

An example representation of the body unit 302 of the wearable interactive gaming device 105 is illustrated with reference to FIG. 5. For example, the body unit 302 in FIG. 5 includes a chest portion 505, a left shoulder portion 510, a right shoulder portion 515, and a back portion 520. The body unit 302 in FIG. 5 can further include a belt 525 that powers up the wearable interactive gaming device 105 on attachment to the chest portion 505. The back portion 520 can mirror any interactions to the chest portion 505.

The arm unit 304 in FIG. 3 includes a liquid crystal (LCD) display unit 322, an LED display unit 324, a controller subsystem 326, an input subsystem 328, a motion processing subsystem 330, an intra-communication subsystem 332, and a battery unit 334. The LCD display unit 322 and the LED display unit 324 are representative of the display unit 205 of FIG. 2. The controller subsystem 326, the input subsystem 328, the intra-communication subsystem 332, and the battery unit 334 is representative of the communication unit 215 of FIG. 2. The motion processing subsystem 330 is representative of the motion sensor unit 210 of FIG. 2.

The arm unit 304 can include one or more portions, for example a wrist portion and a palm top portion. The wrist portion includes the LCD display unit 322, the LED display unit 324, the controller subsystem 326, and the input subsystem 328. The player can use the LCD display unit 322 as a user interface for setting up a game, setting up personal details in the wearable interactive gaming device 105, setting up preferences, color schemes and other personalization options. The palm top portion includes a transmission unit (including, for example, triggers and line of sight code transmission), and the motion processing subsystem 330 for sensing specific gestures of hand performed by the player. The arm unit 304 further includes an intra-communication subsystem 332 to send data to and receive data from the chest portion of the body unit 302. The arm unit 304 also includes the battery unit 334.

An example representation of the arm unit 304 of the wearable interactive gaming device 105 is illustrated with reference to FIG. 6. For example, the arm unit 304 in FIG. 6 includes a wrist portion 605 and a palm top portion 610.

In some embodiments, if the wearable interactive gaming device 105 includes a single wearable unit, for example the body unit 302, then the LED display unit 324, the motion processing subsystem 330, the intra-communication subsystem 332, and the battery unit 334 in FIG. 3 can be single units and are not duplicated.

During a game, the intra-communication subsystem 308 on the body unit 302 and the intra-communication unit 332 on the arm unit 304 can each send or receive data between each other. The mesh communication subsystem 318 communicates the one or more interactions with other wearable interactive gaming devices and robot devices in the vicinity. The one or more interactions are digital codes that depends on a set of rules associated with the game being played. Herein, an ‘interaction’ refers to an action of pointing the arm unit 304 or another wearable unit towards a competing player and pressing one or more controller units (for example, buttons) in the controller subsystem or other similar controller units on the arm unit 304. Some of the controller units on the arm unit 304 is representative of a positive interaction and a negative interaction, respectively, and differ only in code definitions. The transmission unit on the arm unit 304 generates a digital code, which is received by the receiver unit on the body unit 302 of a receiving player. The interaction is handled by the receiving player based on the set of rules associated with the game, and results in updating of LED display unit, the LCD display unit, and sound of the wearable interactive gaming device of the receiving player. The other players in the game are also updated using the mesh communication sub system 318.

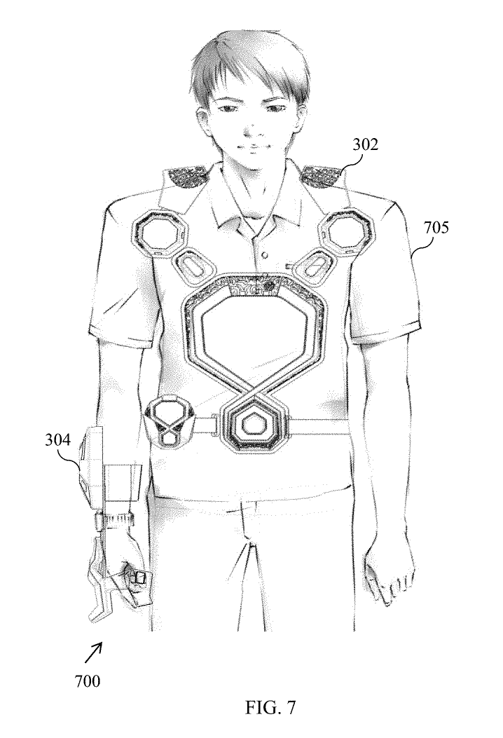

An example representation 700 of the wearable interactive gaming device 105 being worn by the player 705 is illustrated with reference to FIG. 7. The body unit 302 and the arm unit 304 is worn by the player 705 for gaming.

In some embodiments, the wearable interactive gaming device 105 can be used, during playing of the game, in conjunction with one or more robot devices, for example bots, either solely or in groups of 2 to more players. The robot devices can be segregated into teams, or joined in as individual players, based on the game, randomly, with an attempt to cater to preferences. The one or more robot devices are capable of certain amount of intelligence and learning to create a physical alternative of a computer player in traditional video games. The bots have specific personalities and traits, determined by physical capabilities and, for example, one or more intrinsic algorithms. The bots are further able to communicate with other bots and the other wearable interactive gaming devices to figure out game strategies using, for example, artificial intelligence.

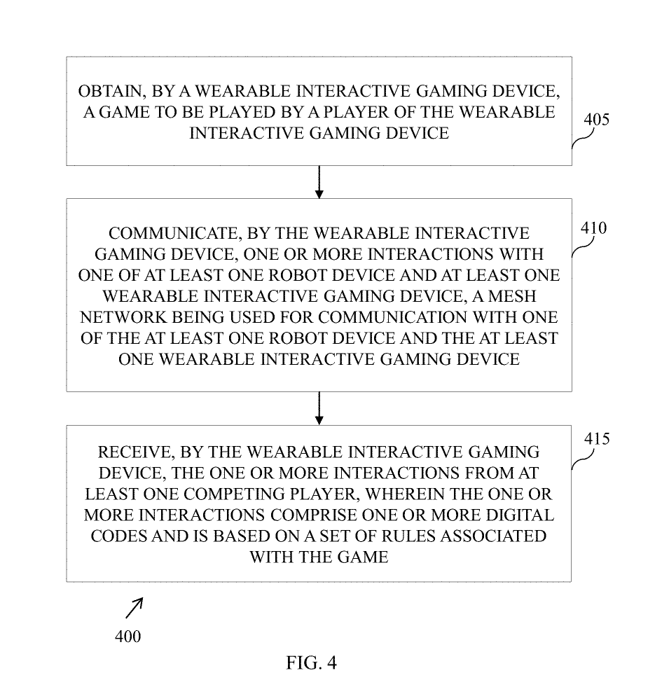

In some embodiments, the wearable interactive gaming device 105 can also connect to a cloud network using an internet connection of a smartphone or similar electronic device to update firmware and games. In one example, the wearable interactive gaming device can connect to the smartphone using Bluetooth Low Energy (BLE). An example method of enabling interactive gaming is explained with reference to FIG. 4.

FIG. 4 illustrates an example flow diagram of a method 400 for enabling interactive gaming, in accordance with an embodiment. At step 405, the method 400 includes obtaining, by a wearable interactive gaming device, for example the wearable interactive gaming device 105 of FIG. 1, a game to be played by a player of the wearable interactive gaming device. The game can be obtained from a cloud network that also includes one or more updates associated with the game. The player can use a display unit, for example the display unit 205 of FIG. 2, to obtain the game.

In some examples, the player is enabled, by the wearable interactive gaming device, to set up the game. Additionally, the player can personalize the wearable interactive gaming device by setting colour schemes, personal details, and the like.

In some examples, a plurality of parameters in the game are displayed to the player. The parameters can be displayed using the display unit of the wearable interactive gaming device.

In some examples, a plurality of gestures performed by the player during the game is sensed by the wearable interactive gaming device. The gestures can be sensed using a motion sensor unit, for example the motion sensor unit 210 of FIG. 2. An appropriate motion sensing algorithm is used by the motion sensor unit for sensing the gestures of the player.

At step 410, the method 400 includes communicating, by the wearable interactive gaming device, one or more interactions with one of at least one robot device and at least one wearable interactive gaming device. The communicating is performed by a communicating unit, for example a communicating unit 215 of FIG. 2. A mesh network can be used for communication with one of the at least one robot device and the at least one wearable interactive gaming device. The method of communicating the one or more interactions by the wearable interactive gaming device is explained with reference to FIG. 2 and FIG. 3 and is not explained herein for sake of brevity.

In some examples, data can also be communicated within the wearable interactive gaming device. For example, the data can be associated with a haptic feedback unit, for example the haptic feedback unit 310 of FIG. 3, a speaker, for example the speaker 312, and an intra-communication subsystem, for example the intra-communication subsystem 308 or the intra-communication subsystem 332.

In some embodiments, one or more controller units can be attached to a hardware interface unit on the wearable interactive gaming device in accordance with the game. For example, buttons can be used as controller units for providing positive and negative interactions in a game. Similarly, joysticks and the like controller units can be attached on to the hardware interface unit as per requirements of the game. The hardware interface unit is a standard interface with published hardware and software specifications that allow other developers to create accessories or controller units that can connect to the wearable interactive gaming device.

At step 415, the method 400 includes receiving, by the wearable interactive gaming device, the one or more interactions from at least one competing player. The one or more interactions are received by a receiver unit, for example the receiver unit 220 of FIG. 2. The one or more interactions include one or more digital codes and is based on a set of rules associated with the game. The method of receiving the one or more interactions is explained in detail with reference to FIG. 2 and FIG. 3 and is not explained herein for sake of brevity.

In some embodiments, a beacon present on the wearable interactive gaming device as a passive device can be detached and used to emulate the at least one competing player. The method of using the beacon is explained in detail with reference to FIG. 2 and FIG. 3 and is not explained herein for sake of brevity.

In some embodiments, operation of the wearable interactive gaming device is enabled on a gaming platform. The gaming platform is used by one or more developers for publishing one or more games.

Various embodiments disclosed herein provide numerous advantages by providing a method and system for enabling interactive gaming. The present invention provides a wearable interactive gaming device capable of reducing screen time, increasing social interaction and encouraging physical activities. The wearable interactive gaming device can be used to play various types of exciting but non-violent games, and takes kids and families outdoors to interact with one another. The wearable interactive gaming device is a personal smart device, which operates on a gaming platform, and also augments as a fitness device that tracks one or more fitness parameters, by use of proprietary motion sensing methods. The wearable interactive gaming device enhances gaming experience and can be played in different areas, for example gardens, parking lots, apartment complexes and the like, in addition to indoor areas and outdoor areas. Architecture of the wearable interactive gaming device allows development of game titles similar to conventional computer or mobile gaming. Further, the wearable interactive gaming device also allows a player to experience different games available over a proprietary store. The wearable interactive gaming device can also play games with the bots, interact with other players in ways not possible earlier. The wearable interactive gaming device is a standalone distributed system capable of communicating to other wearable interactive gaming devices without needing a smartphone or internet connection.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A wearable interactive gaming device comprising:
at least one wearable unit, wearable on a player, the at least one wearable unit comprising:
a display unit configured to enable setting up of a game by the player, the display unit further configured to indicate, to the player, a plurality of parameters in the game;
a motion sensor unit configured to sense a plurality of gestures performed by the player during the game;
a communication unit configured to communicate one or more interactions with one of at least one robot device and at least one wearable interactive gaming device, the communication unit further configured to communicate data within the wearable interactive gaming device, the communication unit using a mesh network to communicate with one of the at least one robot device and the at least one wearable interactive gaming device; and
a receiver unit configured to receive the one or more interactions from at least one competing player, wherein the one or more interactions comprise one or more digital codes and is based on a set of rules associated with the game.

2. The wearable interactive gaming device as claimed in claim 1 and further comprising:
a beacon configured to emulate the at least one competing player on detachment from the wearable interactive gaming device.

3. The wearable interactive gaming device as claimed in claim 2, wherein the motion sensor unit is further configured to track one or more fitness parameters of the player.

4. The wearable interactive gaming device as claimed in claim 1, wherein the communication unit further comprises:
a hardware interface unit configured to allow attachment of one or more controller units in accordance with the game.

5. The wearable interactive gaming device as claimed in claim 4, wherein the communication unit further comprises:
a mesh communication subsystem configured to communicate one or more interactions with one of the at least one robot device and the at least one wearable interactive gaming device.

6. The wearable interactive gaming device as claimed in claim 5, wherein the communication unit further comprises:
a speaker configured to provide one or more audio outputs associated with the game.

7. The wearable interactive gaming device as claimed in claim 6, wherein the wearable interactive gaming device is further configured to connect to a cloud network for retrieving one or more updates associated with the game.

8. The wearable interactive gaming device as claimed in claim 1, wherein the wearable interactive gaming device operates on a gaming platform, the gaming platform being used by one or more developers for publishing one or more games.

9. A method of enabling interactive gaming, the method comprising:
obtaining, by a wearable interactive gaming device, a game to be played by a player of the wearable interactive gaming device;
communicating, by the wearable interactive gaming device, one or more interactions with one of at least one robot device and at least one wearable interactive gaming device, a mesh network being used for communication with one of the at least one robot device and the at least one wearable interactive gaming device; and
receiving, by the wearable interactive gaming device, the one or more interactions from at least one competing player, wherein the one or more interactions comprise one or more digital codes and is based on a set of rules associated with the game.

10. The method as claimed in claim 9 and further comprising:
enabling, by the wearable interactive gaming device, the player to set up the game.

11. The method as claimed in claim 10 and further comprising:
displaying, by the wearable interactive gaming device, a plurality of parameters in the game to the player.

12. The method as claimed in claim 11 and further comprising:
sensing, by the wearable interactive gaming device, a plurality of gestures performed by the player during the game.

13. The method as claimed in claim 12 and further comprising:
enabling, by the wearable interactive gaming device, a beacon to emulate the at least one competing player on detachment from the wearable interactive gaming device.

14. The method as claimed in claim 13, wherein communicating the one or more interactions comprises:
communicating data within the wearable interactive gaming device.

15. The method as claimed in claim 14, wherein communicating the one or more interactions further comprises:
allowing, by the wearable interactive gaming device, attachment of one or more controller units in accordance with the game.

16. The method as claimed in claim 15 and further comprising:
enabling, by the wearable interactive gaming device, operation on a gaming platform, the gaming platform being used by one or more developers for publishing one or more games.
